(19) United States
(12) Patent Application Publication
(10) Pub. No.: US 2025/0036908 A1
(43) Pub. Date: Jan. 30, 2025

(54) RF TAG

(71) Applicant: TATEYAMA KAGAKU CO., LTD., Toyama (JP)

(72) Inventors: Kenichi HONDA, Toyama (JP); Takumi HIGA, Toyama (JP); Yuki NAKAMATA, Toyama (JP)

(21) Appl. No.: 18/912,641

(22) Filed: Oct. 11, 2024

Related U.S. Application Data
(63) Continuation of application No. PCT/JP2022/019276, filed on Apr. 28, 2022.

(51) Int. Cl. G06K 19/077

(52) U.S. Cl. CPC G06K 19/0772

(57) ABSTRACT

An RF tag is an RF tag capable of transmitting and receiving data via radio waves that includes a plate-like substrate that is formed of a dielectric, a loop-shaped conductive pattern that is formed on one or more surfaces of the plate-like substrate, a semiconductor device that is provided between a first end and a second end of the conductive pattern, and a first cover member that covers at least a portion of the conductive pattern, wherein the RF tag has characteristics in which a gain increases while a resonance frequency shifts toward a lower frequency as an external dielectric approaches the RF tag, and an area of the conductive pattern on a bottom surface of the plate-like substrate is equal to or larger than an area of the conductive pattern on a top surface of the plate-like substrate.

### CROSS-REFERENCE TO RELATED APPLICATIONS

The present application is a continuation application of International Application number PCT/JP2022/019276, filed on Apr. 28, 2022, contents of which are incorporated herein by reference in their entirety.

### BACKGROUND OF THE INVENTION

The present disclosure relates to an RF tag.

Conventionally, an RF tag intended for use while attached to a conductor has been known (for example, see Patent Document 1).

### PRIOR ART

### Patent Document

Patent Document 1: Japanese Patent No. 6463178.

Patent Document 1 discloses an RF tag with a dielectric provided between the conductive layer and the antenna, and the dielectric electromagnetically couples the in-plane propagation wave generated in the conductive layer with the antenna, thereby enhancing the gain of the antenna. The conductive layer of a conventional RF tag is formed of a large number of biaxially symmetric structures, each having a pair of tapered sections that become wider as they extend away from a constricted portion, and a large-area conductive layer is required to ensure sufficiently large antenna gain, which results in a larger RF tag.

Reducing an area of the conductive layer to miniaturize the RF tag results in a decrease in its gain and significant fluctuations in the resonance frequency when an external dielectric approaches. Therefore, it has been desired to suppress resonance frequency fluctuation while keeping an RF tag small.

The present disclosure focuses on this point, and an object thereof is to suppress fluctuations in resonance frequency of an RF tag.

### BRIEF SUMMARY OF THE INVENTION

An RF tag of the present disclosure is an RF tag capable of transmitting and receiving data via radio waves that includes a plate-like substrate that is formed of a dielectric, a loop-shaped conductive pattern that is formed on one or more surfaces of the plate-like substrate, a semiconductor device that is provided between a first end and a second end of the conductive pattern, stores the data, and includes a circuit transmitting and receiving the data via radio waves, and, a first cover member that covers at least a portion of the conductive pattern above the conductive pattern on a top surface of the plate-like substrate and has a first dielectric constant that is higher than a dielectric constant of the plate-like substrate, wherein the RF tag has characteristics in which i) a gain increases while a resonance frequency shifts toward a lower frequency as an external dielectric approaches the RF tag, ii) a resonance frequency when the external dielectric is in contact with the RF tag is lower than a resonance frequency when the external dielectric is not in contact with the RF tag, and iii) the gain is larger when the external dielectric is in contact with the RF tag than when the external dielectric is not in contact with the RF tag, and an area of the conductive pattern on a bottom surface of the plate-like substrate is equal to or larger than an area of the conductive pattern on a top surface of the plate-like substrate.

### BRIEF DESCRIPTION OF THE DRAWINGS

FIG. 1 illustrates an overview of an RF tag 1.

FIG. 2A is a perspective view of the RF tag 1.

FIG. 2B is a top view of the RF tag 1.

FIG. 2C is a bottom view of the RF tag 1.

FIG. 3 is a cross-sectional view of an RF tag 1a which is an example of the RF tag 1.

FIG. 4 is a cross-sectional view of an RF tag 1b which is another example of the RF tag 1.

FIG. 5 is a cross-sectional view of an RF tag 1c which is another example of the RF tag 1.

FIG. 6A shows a configuration of an RF tag 1d, which is an example of an RF tag 1a with a plate-like second cover member 16 overlaid on it.

FIG. 6B shows frequency characteristics of the RF tag 1d.

FIG. 7A shows a configuration of an RF tag 1e according to another embodiment.

FIG. 7B shows frequency characteristics of the RF tag 1e.

FIG. 8A shows a configuration of an RF tag 1f according to a further embodiment.

FIG. 8B shows frequency characteristics of the RF tag 1f.

FIG. 9A shows a configuration of an RF tag 1g according to another embodiment.

FIG. 9B shows a configuration of an RF tag 1h according to another embodiment.

FIG. 9C shows frequency characteristics of the RF tag 1g and the RF tag 1h.

FIG. 10A shows a configuration of an RF tag 1j according to another embodiment.

FIG. 10B shows a configuration of an RF tag 1k according to another embodiment.

FIG. 10C shows frequency characteristics of the RF tag 1j and the RF tag 1k.

### DETAILED DESCRIPTION OF THE INVENTION

Hereinafter, the present disclosure will be described through exemplary embodiments of the present disclosure, but the following exemplary embodiments do not limit the disclosure according to the claims, and not all of the combinations of features described in the exemplary embodiments are necessarily essential to the solution means of the disclosure.

### Overview of RF Tag 1

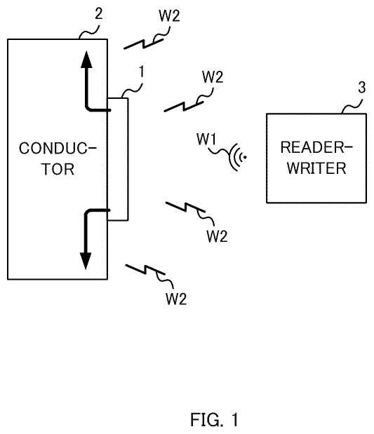

FIG. 1 illustrates an overview of an RF tag 1. The RF tag 1 is a device capable of transmitting and receiving data via radio waves. The RF tag 1 operates using power generated by receiving a radio wave W1 transmitted from a reader-writer 3 while attached to a conductor 2. The RF tag 1 emits a radio wave W2 that is superimposed with data stored in a built-in semiconductor device.

The conductor 2 is an object that can carry an electric current and is a metal, for example. The conductor 2 is not limited to being metal, and may be wood or a resin containing a material that can carry an electric current. Further, the thickness of the conductor 2 in the mounting direction of the RF tag 1 is arbitrary, and the conductor 2 may be a metal foil that can carry an electric current.

The RF tag 1 and the conductor 2 are capacitively coupled, therefore the radio wave W2 generated by the RF tag 1 is also emitted through the conductor 2. As a result, even if the reader-writer 3 is present in a location where it is difficult to receive the radio wave W2 emitted by the RF tag 1, the reader-writer 3 can still obtain the data stored in the RF tag 1 by receiving the radio wave W2 via the conductor 2.

The RF tag 1 includes a main body and a cover member provided to cover at least a portion of the main body. A dielectric constant of the cover member is higher than a dielectric constant of a plate-like substrate included in the main body. The RF tag 1 includes such a cover member, and so it is possible to suppress fluctuations in the resonance frequency of the RF tag 1 when a dielectric approaches the RF tag 1 from the outside. It should be noted that the term “dielectric constant” as used herein includes a dielectric constant measured when a plurality of materials are mixed, as well as a dielectric constant measured when a material contains a void (that is, an apparent dielectric constant).

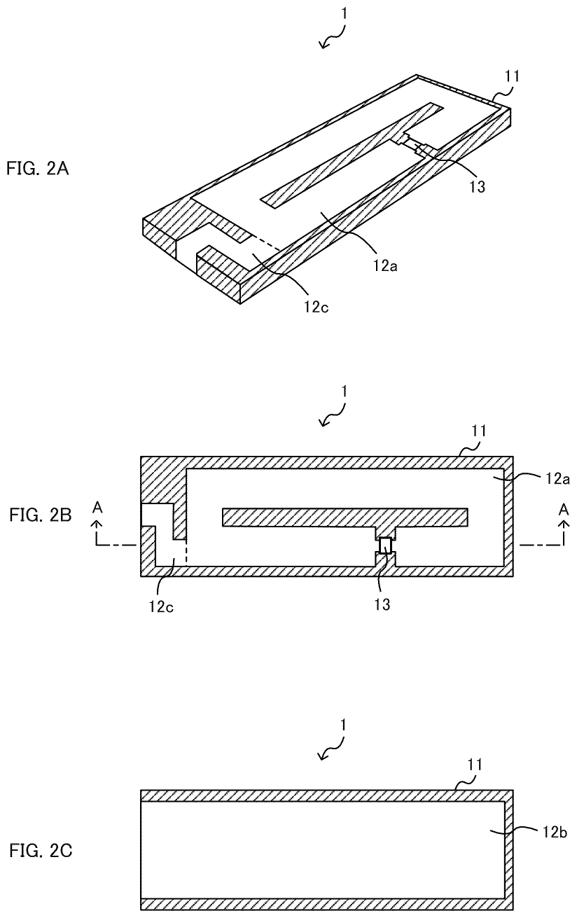

FIGS. 2A to 2C show a configuration of the main body of the RF tag 1. The main body of the RF tag 1 is the RF tag 1 without the cover member. FIG. 2A is a perspective view of the RF tag 1. FIG. 2B is a top view of the RF tag 1. FIG. 2C is a bottom view of the RF tag 1. The main body of the RF tag 1 includes a plate-like substrate 11, a conductive pattern 12, and a semiconductor device 13. The shape of the conductive pattern 12 shown in FIGS. 2A to 2C is one example, and the shape of the conductive pattern 12 of the RF tag 1 is arbitrary, as will be described later.

Although not shown in FIGS. 2A to 2C, the conductive pattern 12 and the semiconductor device 13 may be provided on a sheet-like dielectric member (for example, flexible substrate) and fixed to the plate-like substrate 11 integrally with the sheet-like dielectric member. In this case, i) the conductive pattern 12 and the semiconductor device 13 need not be in contact with the plate-like substrate 11 because the sheet-like dielectric member is in contact with the plate-like substrate 11, or ii) the conductive pattern 12 and the semiconductor device 13 may be provided between the sheet-like dielectric member and the plate-like substrate 11.

The conductive pattern 12 is formed in a loop shape on one or more surfaces of the plate-like substrate 11. The conductive pattern 12 includes a top surface conductive pattern 12a, a bottom surface conductive pattern 12b, and a connection conductive pattern 12c. The conductive pattern 12 may have a loop formed with the top surface conductive pattern 12a on a top surface of the RF tag 1, as shown in FIGS. 2A to 2C, may have a loop formed with a conductive pattern extending over the top surface and a connection surface of the RF tag 1, or may have a loop formed with a conductive pattern extending over the top surface, the connection surface, and a bottom surface of the RF tag 1. The loop formed with the conductive pattern 12 may be formed so that 50% or more of a region, enclosed by the conductive pattern 12, is on a single surface (for example, the top surface).

The plate-like substrate 11 is formed of a dielectric. In the example shown in FIGS. 2A to 2C, shapes of a top surface and a bottom surface of the plate-like substrate 11 are rectangular, but shapes of the top surface and the bottom surface of the plate-like substrate 11 may be polygonal, oval, or elliptical instead of rectangular.

The top surface conductive pattern 12a is a loop-shaped conductive pattern formed on the top surface of the plate-like substrate 11. The inside of the loop formed with the top surface conductive pattern 12a exposes the plate-like substrate 11. A portion of the loop formed with the top surface conductive pattern 12a has a region where no conductive pattern is formed, and the semiconductor device 13 is provided in that region.

The bottom surface conductive pattern 12b is a conductive pattern formed on the bottom surface of the plate-like substrate 11. The bottom surface conductive pattern 12b has a rectangular shape, for example. An area of the bottom surface conductive pattern 12b is i) equal to or larger than an area of the top surface conductive pattern 12a and ii) smaller than an area of the bottom surface of the plate-like substrate 11.

The connection conductive pattern 12c is a conductive pattern that connects the top surface conductive pattern 12a and the bottom surface conductive pattern 12b. The connection conductive pattern 12c is configured to extend from a partial region of the top conductive pattern 12a, pass along the side surface of the plate-like substrate 11, and terminate at a partial region of the bottom conductive pattern 12b. In the example shown in FIGS. 2A to 2C, the connection conductive pattern 12c connects to the top conductive pattern 12a at a position along a straight line parallel to the longitudinal direction of the plate-like substrate 11 that is passing through one end of the top conductive pattern 12a, the semiconductor device 13, and the other end of the top conductive pattern 12a.

The semiconductor device 13 includes a memory for storing data to be transmitted to the reader-writer 3. The semiconductor device 13 is provided between a first end and a second end of the conductive pattern 12. In the example shown in FIGS. 2A to 2C, the semiconductor device 13 is provided between the one end and the other end of the top surface conductive pattern 12a. Specifically, the semiconductor device 13 is provided between the one end and the other end in a region of the top surface conductive pattern 12a that extends in the longitudinal direction of the plate-like substrate 11.

Further, the semiconductor device 13 includes a circuit that transmits and receives data stored in the memory via radio waves. The semiconductor device 13 may incorporate a plurality of capacitors for adjusting the resonance frequency. In this case, the semiconductor device 13 can adjust the resonance frequency by adjusting the capacitance between the one end and the other end of the top surface conductive pattern 12a by switching one or more capacitors connected between the one end and the other end of the top surface conductive pattern 12a. The semiconductor device 13 adjusts the capacitance so that the intensity of a received radio wave is maximized, for example.

Assuming that the inductance of the RF tag 1 is L and the capacitance thereof is C, the resonance frequency f is represented by 1/(2*π*SQRT (LC)). In order to change the resonance frequency as large as possible by adjusting the capacitance of the semiconductor device 13, it is desirable to reduce the capacitance of the RF tag 1 as much as possible when the semiconductor device 13 is not provided. Accordingly, in order to increase the inductance of the RF tag 1, it is desirable that the area where the loop of the conductive pattern 12 overlaps with the bottom conductive pattern 12b is 50% or more of the area of the top surface of the plate-like substrate 11.

Incidentally, since a frequency band of the radio wave through which the RF tag 1 can communicate with the reader-writer 3 is defined within a predetermined range, it is undesirable for the resonance frequency of the RF tag 1 to fluctuate due to the surrounding environment of the RF tag 1. Accordingly, the RF tag 1 is provided with a cover member having a dielectric constant larger than that of the plate-like substrate 11. The dielectric constant of the plate-like substrate 11 is a dielectric constant of the plate-like dielectric constituting the plate-like substrate 11, for example.

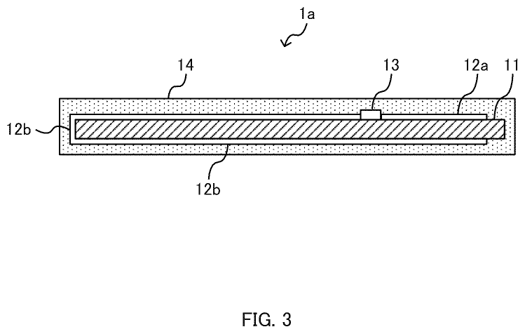

FIG. 3 shows a cross-sectional view of an RF tag 1a which is an example of the RF tag 1. FIG. 3 shows an A-A-line cross-section of FIG. 2B. As shown in FIG. 3, the RF tag 1a further includes a first cover member 14. The first cover member 14 is provided above the conductive pattern 12 on the top surface of the RF tag 1a so as to cover at least a portion of the conductive pattern 12. The thickness of the first cover member 14 is 100 μm or more, for example.

The first cover member 14 covers the entire region of the top surface of the plate-like substrate 11, for example, but may cover 50% or more of the region of the conductive pattern 12 on the top surface of the plate-like substrate 11. The first cover member 14 does not have to cover the entire region of the top surface of the plate-like substrate 11, and may cover at least a portion of the region of the loop formed with the conductive pattern 12. Covering at least a portion of the region of the loop formed with the conductive pattern 12 means covering at least a portion of the region of the conductive pattern 12 that is in contact with that region surrounded by the conductive pattern 12. The first cover member 14 may cover i) a region surrounded by the conductive pattern 12 and the semiconductor device 13 and ii) a region of the conductive pattern 12 that is in contact with that region.

The first cover member 14 desirably covers 50% or more of the area of the top surface of the plate-like substrate 11. Further, as shown in FIG. 3, the first cover member 14 may further cover at least a portion of the region of the conductive pattern 12 on the side surface and the bottom surface of the plate-like substrate 11.

As described above, the dielectric constant of the first cover member 14 (hereinafter referred to as a “first dielectric constant”) is higher than the dielectric constant of the plate-like substrate 11. The first dielectric constant is 2 or more and 10 or less, for example. Examples of the material of the first cover member 14 include glass, acrylic resin, acrylic nitrile resin, acetal resin, cellulose resin, aniline resin, AS resin, ABS resin, ethylene resin, epoxy resin, vinyl resin, vinylidene resin, casein resin, natural/synthetic rubber, polyvinyl butyral resin, urea resin, vinyl formal resin, fluorine resin, furan resin, polycarbonate resin, polybutylene resin, polypropylene resin, melamine resin, polyphenylene sulfide resin, polyether ether ketone resin, polyurethane resin/rubber, silicon resin/rubber, polyester resin, phenol resin, diallyl phthalate resin, styrene resin, styrol resin, celluloid, polyamide resin, polyimide resin, polyamide-imide resin, and polymethylpentene resin.

The first cover member 14 may be made of any one of these materials, or may be made of two or more of the materials. Further, the first cover member 14 may be made of a resin containing powder of a high dielectric material such as glass or ceramics. Details will be described later with reference to experimental data, but the RF tag 1a, having such a first cover member 14, exhibits a smaller amount of reactance change when an external dielectric approaches the RF tag 1a compared to when the RF tag 1a does not have the first cover member 14, and so the amount of fluctuation in the resonance frequency is reduced.

It should be noted that the first cover member 14 shown in FIG. 3 has a uniform thickness on the top, side, and bottom surfaces of the plate-like substrate 11, but the thickness on the bottom surface may be smaller than the thickness on the top surface. Further, the material of the first cover member 14 on the top surface of the plate-like substrate 11 may be different from the material of the first cover member 14 on the side surfaces or the bottom surface of the plate-like substrate 11.

Furthermore, a gap (for example, a concave portion) may be formed between the first cover member 14 and the top surface conductive pattern 12a or between the first cover member 14 and the semiconductor device 13. The formation of such a gap can reduce the stress applied to the top surface conductive pattern 12a or the semiconductor device 13 when the RF tag 1 is bent.

In addition, a plurality of plate-like members having the first dielectric constant may be stacked in the first cover member 14. For example, the plate-like member is a member thinner than the plate-like substrate 11. If the first cover member 14 is configured in this manner, the reactance of the RF tag 1a caused by the first cover member 14 can be easily changed by changing the number of plate-like members to be stacked, thereby making it easier to adjust the characteristics of the RF tag 1.

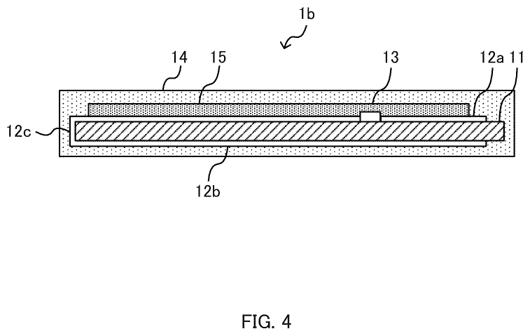

FIG. 4 is a cross-sectional view of an RF tag 1b which is another example of the RF tag 1. The RF tag 1b is different from the RF tag 1a in that it further includes an intermediate layer 15, having a second dielectric constant that is lower than the first dielectric constant, between a) at least a portion of the top surface conductive pattern 12a and the semiconductor device 13 and b) the first cover member 14, and is the same in other respects. The intermediate layer 15 is a solid, for example, but may be a gas. Further, instead of the intermediate layer 15 or together with the intermediate layer 15, the RF tag 1b may have a gap between a) at least a portion of the top surface conductive pattern 12a and the semiconductor device 13 and b) the first cover member 14.

It should be noted that, in the structure shown in FIG. 4, the dielectric constant of the intermediate layer 15 may be higher than the dielectric constant of the plate-like substrate 11, and the dielectric constant of the intermediate layer 15 may be higher than the dielectric constant of the first cover member 14. In this case, the intermediate layer 15 covers at least a portion of the loop formed with the conductive pattern 12 above the conductive pattern on the top surface of the plate-like substrate 11, and functions as a first cover member having a dielectric constant higher than that of the plate-like substrate 11.

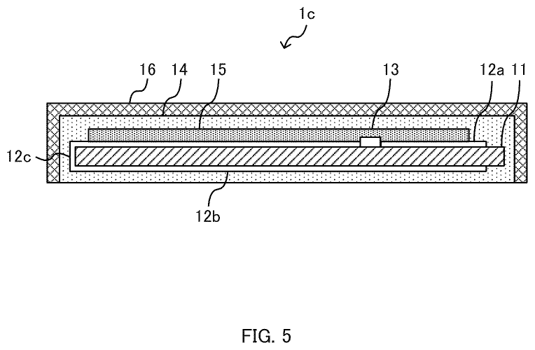

FIG. 5 is a cross-sectional view of an RF tag 1c which is another example of the RF tag 1. The RF tag 1c further includes a second cover member 16, having a third dielectric constant that is higher than the first dielectric constant, that covers the first cover member 14. A plurality of plate-like members having the third dielectric constant may be stacked in the second cover member 16. Although the second cover member 16 shown in FIG. 5 is provided so as to cover the top surface and the side surfaces of the plate-like substrate 11, the second cover member 16 may be configured to cover only 50% or more of the region of the top surface of the plate-like substrate 11. The RF tag 1c may have a gap between the first cover member 14 and the second cover member 16.

In the structure shown in FIG. 5, the dielectric constant of the intermediate layer 15 may be higher than the dielectric constant of the plate-like substrate 11, and the dielectric constant of the intermediate layer 15 may be higher than the dielectric constant of the first cover member 14. In addition, the dielectric constant of the second cover member 16 may be higher than the dielectric constant of the intermediate layer 15.

### [Comparison of Frequency Characteristics]

Hereinafter, effects of the RF tag 1 will be described with reference to frequency characteristics of various types of RF tags 1.

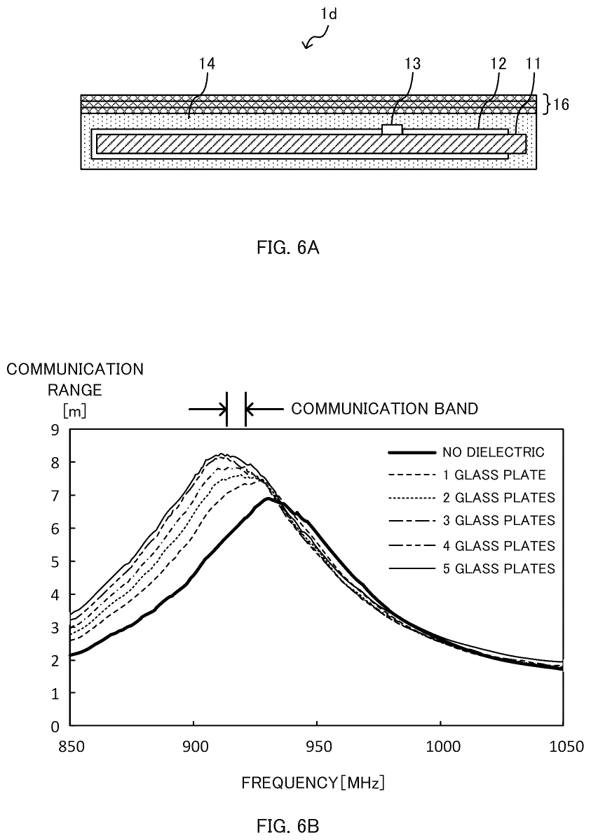

FIG. 6A shows a configuration of an RF tag 1d, which is an example of an RF tag 1a with a plate-like second cover member 16 overlaid on it.

The plate-like substrate 11 of the RF tag 1d shown in FIG. 6A has a dielectric constant of 1.7, and the first cover member 14 is a dielectric having a dielectric constant of 3.9. The first cover member 14 is made of polyphenylene sulfide (PPS) resin containing a glass filler having a thickness of 2 mm. The second cover member 16 is made of a glass plate having a dielectric constant of 7.1 and a thickness of 1 mm. The frequency characteristics of the RF tag 1d were measured while changing the number of glass plates constituting the second cover member 16, with each RF tag 1d having a different number of glass plates.

FIG. 6B shows the frequency characteristics of the RF tag 1d. The horizontal axis represents frequency, and the vertical axis represents a range in which the RF tag 1d can communicate with the reader-writer 3. FIG. 6B shows the frequency characteristics when the RF tag 1d does not have the second cover member 16, and when the second cover member 16 has 1, 2, 3, 4, or 5 glass plates.

The inventors of the present disclosure found that as the number of glass plates included in the second cover member 16 increases, the gain increases as the resonant frequency is shifted toward a lower frequency, as shown in FIG. 6B. Then, the inventors found that as the number of glass plates increases, the degree of the shift in the resonance frequency to a lower frequency decreases, and that fluctuation in the resonance frequency due to the increase in the number of glass plates from four to five becomes minimal.

The inventors of the present disclosure found that by utilizing this principle, the RF tag 1d, which has a cover member possessing a higher dielectric constant than that of the plate-like substrate 11, can reduce the fluctuation in the resonant frequency when a dielectric approaches from the outside, compared to the case where the RF tag 1d does not have the cover member.

Specifically, in the example shown in FIG. 6B, the resonance frequency of the RF tag 1d without the second cover member 16 (no dielectric) was about 930 MHz, and the resonance frequency when a dielectric approaches from the outside (corresponding to “five glass plates”) was approximately 910 MHz, resulting in a fluctuation of about 20 MHz in the resonant frequency. In contrast, when the communication band was set to 910 to 920 MHz and the RF tag 1d included the second cover member 16 in which two or three glass plates were stacked, the fluctuation in the resonance frequency when a dielectric approached from the outside was suppressed to between 0 and 10 MHZ. In addition, it was also confirmed that the gain increases and the communication performance is improved as an external dielectric approaches the RF tag 1.

That is, the RF tag 1 has the following characteristics: i) the gain increases as the resonance frequency shifts toward a lower frequency as an external dielectric approaches the RF tag 1, and ii) the resonance frequency when an external dielectric is in contact with the RF tag 1 is lower than the resonance frequency when an external dielectric is not in contact with the RF tag 1, and the gain when an external dielectric is in contact with the RF tag 1 is greater than the gain when an external dielectric is not in contact with the RF tag 1.

Although the RF tag 1d shown in FIG. 6A includes both the first cover member 14 and the second cover member 16, it can be understood, considering the above principle, that the RF tag 1, by having a cover member that covers at least a portion of the main body of the RF tag 1, can reduce the fluctuation in the resonance frequency.

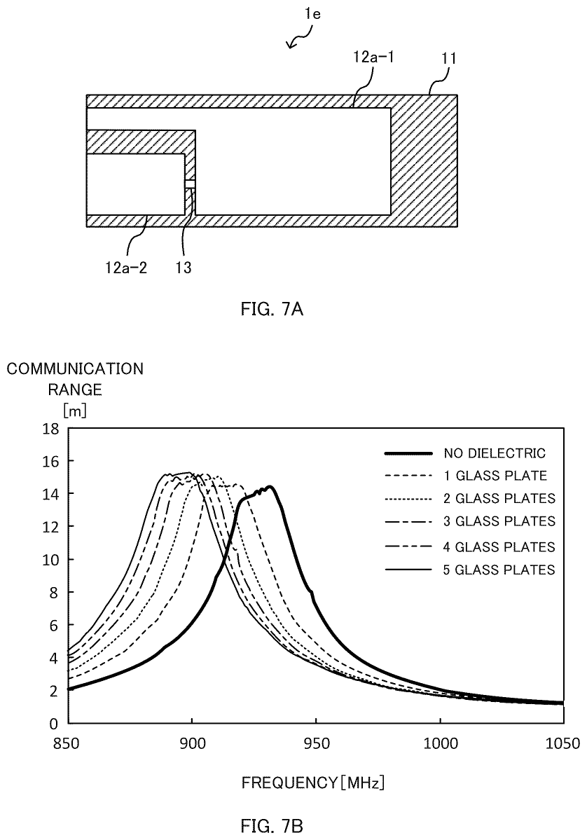

FIG. 7A shows a configuration of an RF tag 1e according to another embodiment. As shown in a plan view of the RF tag 1e shown in FIG. 7A, the shape of the conductive pattern 12 of the RF tag 1e is different from that of the RF tag 1d. The conductive pattern 12 of the RF tag 1e does not form a loop only on the upper surface of the plate-like substrate 11, but forms a loop across the top, side, and bottom surfaces. That is, the loop is formed with each of a top surface conductive pattern 12a-1 and a top surface conductive pattern 12a-2 being connected to a bottom surface conductive pattern 12b via the side surface.

The plate-like substrate 11 of the RF tag 1e is formed of a material having a dielectric constant of 1.8. The first cover member 14 is made of industrial vinyl chloride having a thickness of 0.3 mm and a dielectric constant of 2.8. The cross-sectional shape of the first cover member 14 is equivalent to the cross-sectional shape of the first cover member 14 of the RF tag 1d shown in FIG. 6A, and the second cover member 16 is made of a glass plate having a dielectric constant of 7.1 and a thickness of 1 mm.

FIG. 7B shows frequency characteristics of the RF tag 1e. As shown in FIG. 7B, a trend of the frequency characteristics of the RF tag 1e was equivalent to a trend of the frequency characteristics of the RF tag 1d shown in FIG. 6B. That is, as the number of glass plates increases, the resonance frequency shifted toward a lower frequency and the communication range became larger. Based on this result, it was confirmed that, regardless of the shape of the conductive pattern 12, the effect of suppressing fluctuation in the resonance frequency can be achieved by providing the dielectric having a higher dielectric constant than the dielectric constant of the plate-like substrate 11 so as to cover the conductive pattern 12. It should be noted that, the semiconductor device 13 included in the RF tag 1e has a function of adjusting the capacitance to maximize the intensity of the received radio wave, and so the communication range is close to the maximum value in a relatively wide frequency range. The same applies to RF tags 1f to 1k described later.

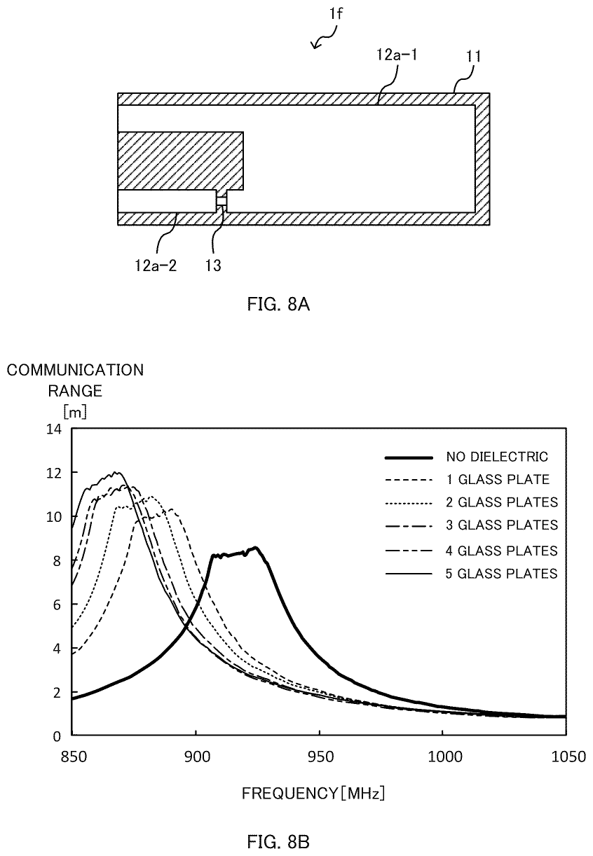

FIGS. 8A and 8B show a configuration and frequency characteristics of an RF tag 1f according to a further embodiment. As shown in a plan view of FIG. 8A, a shape of the conductive pattern 12 of the RF tag 1f is similar to that of the RF tag 1e, but a loop diameter (that is, the size of the region surrounded by the conductive pattern 12) and an area of the top surface conductive pattern 12a-1 are larger than those of the RF tag 1e. Further, the dielectric constant of the plate-like substrate 11 is 1.1. The RF tag 1f is equivalent to the RF tag 1e in other respects.

FIG. 8B shows frequency characteristics of the RF tag 1f. As shown in FIG. 8B, a trend of the frequency characteristics of the RF tag 1f was equivalent to the trend of the frequency characteristic of the RF tag 1d shown in FIG. 6B. The semiconductor device 13 included in the RF tag 1f also has a function of adjusting the capacitance to maximize the intensity of the received radio wave, so the communication range is near its maximum value over a relatively wide frequency range. However, the RF tag 1f differs from the RF tags 1d and 1e in that, as the number of glass plates in the second cover member 16 increases, the fluctuation of the resonance frequency and the amount of increase in the communication range are larger than those of the RF tag 1d and the RF tag 1e. This is considered to be due to the large ratio of the area of the top surface conductive pattern 12a-1 to the area of the bottom surface conductive pattern 12b formed on a surface of the plate-like substrate 11.

From this, it is considered desirable that the area of the top conductive pattern 12a be larger relative to the area of the bottom conductive pattern 12b in order to increase the communicable range. Specifically, it is desirable that the area of the top conductive pattern 12a is at least 50% of the area of the bottom conductive pattern 12b, and it is even more desirable that the area of the top conductive pattern 12a is at least 80% of the area of the bottom conductive pattern 12b.

On the other hand, the RF tag 1f shown in FIG. 8B has a greater fluctuation in the resonant frequency due to changes in the thickness of the dielectric, compared to the RF tag 1d shown in FIG. 6B. From this, since an excessive fluctuation amount in the resonant frequency may lead to a decrease in manufacturing yield, it may be desirable that the area of the top conductive pattern 12a be 80% or less of the area of the bottom conductive pattern 12b. The ratio of the area of the top surface conductive pattern 12a to the area of the bottom surface conductive pattern 12b may be determined according to required specifications of the RF tag 1. However, to ensure an appropriate communication range and yield, it is desirable for the ratio of the area of the top conductive pattern 12a to the area of the bottom conductive pattern 12b to be 50% or more and 80% or less, for example.

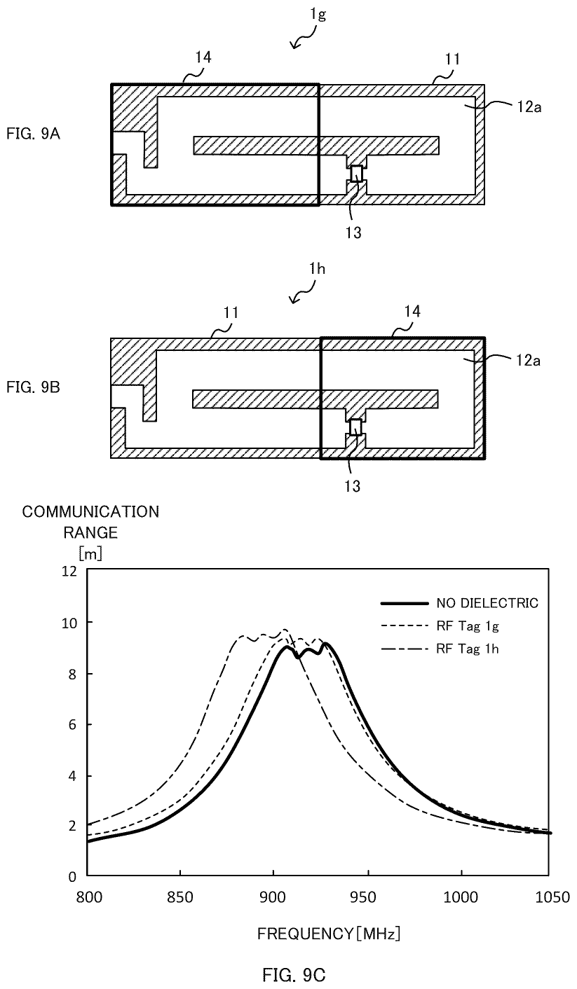

FIG. 9A shows a configuration of an RF tag 1g according to another embodiment. FIG. 9B shows a configuration of an RF tag 1h according to another embodiment. As shown in a plan view of the RF tag 1g shown in FIG. 9A and a plan view of the RF tag 1h shown in FIG. 9B, the RF tag 1g and the RF tag 1h have the same shape of the conductive pattern 12 as that of the RF tag 1 shown in FIG. 2B, but differ in size and position of the first cover member 14.

In the RF tag 1g, the first cover member 14 is provided around a portion (left side in figure) where the top surface conductive pattern 12a is connected to the bottom surface conductive pattern 12b, and in the RF tag 1h, the first cover member 14 is provided around a portion (right side in figure) opposite to the portion where the top surface conductive pattern 12a is connected to the bottom surface conductive pattern 12b.

FIG. 9C shows frequency characteristics of the main bodies of the RF tag, in which the first cover member 14 (dielectric) is not provided, the RF tag 1g, and the RF tag 1h. As shown in FIG. 9C, the RF tag 1h has a greater fluctuation in the resonance frequency due to the provision of the first cover member 14. Therefore, fluctuation in the resonance frequency when an external dielectric approaches or is in contact with the RF tag 1h is considered to be smaller than fluctuation in the resonance frequency when an external dielectric approaches or is in contact with the RF tag 1g.

This result is believed to occur because the potential difference between the top conductive pattern 12a and the bottom conductive pattern 12b is small near the connection position but increases as the distance from the connection position increases, making it more susceptible to changes in reactance caused by the first cover member 14. This indicates that by positioning the first cover member 14 in a region farther from the connection position between the top conductive pattern 12a and the bottom conductive pattern 12b relative to the center position of the RF tag 1, the resonance frequency of the RF tag 1 can be lowered, making it less susceptible to the influence of an external dielectric. The first cover member 14 may be configured to cover 50% or more of the region of the conductive pattern 12 on the top surface of the plate-like substrate 11 so that the first cover member 14 covers the region farther from the connection position.

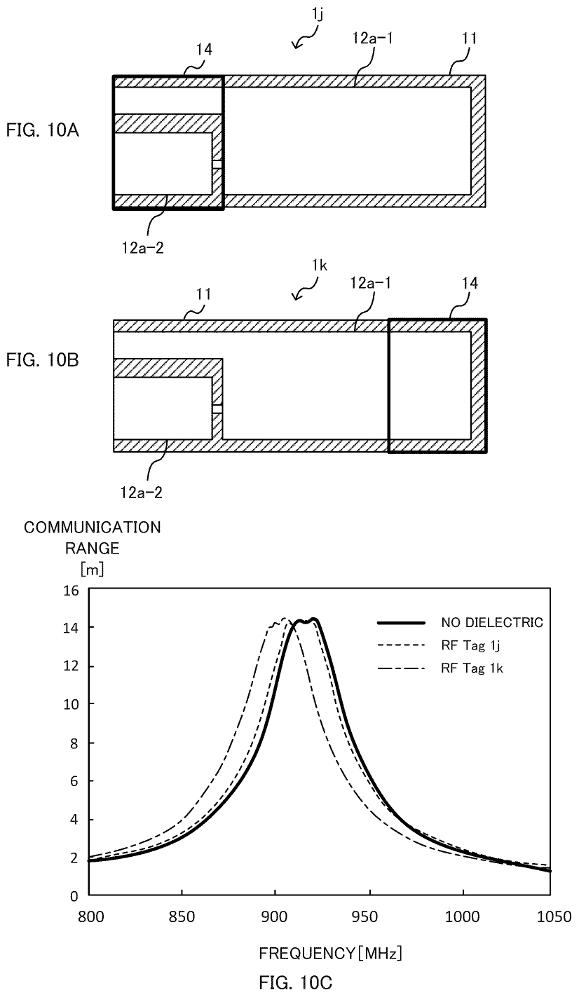

FIG. 10A shows a configuration of an RF tag 1j according to another embodiment. FIG. 10B shows a configuration of an RF tag 1k according to another embodiment. In the RF tag 1j shown in FIG. 10A, the first cover member 14 is provided in a loop-shaped region formed with the conductive pattern 12. In the RF tag 1k shown in FIG. 10B, the first cover member 14 is provided in the region farthest from the connection position between the top conductive pattern 12a and the bottom conductive pattern 12b, without including the loop-shaped region formed with the conductive pattern 12.

FIG. 10C shows frequency characteristics of the RF tag 1j and the RF tag 1k. As shown in the frequency characteristics of FIG. 10C, in the RF tag 1k, although the first cover member 14 covers only a partial region of the conductive pattern 12a-1, the resonance frequency is greatly shifted toward a lower frequency. From this, it was confirmed that the RF tag 1 was less likely to be susceptible to an external dielectric by having the first cover member 14 covering at least a portion of the top surface conductive pattern 12a.

### [Effects of RF Tag 1]

As described above, the RF tag 1 includes i) the loop-shaped conductive pattern 12 formed on one or more surfaces of the plate-like substrate 11, ii) the semiconductor device provided between the first end and the second end of the conductive pattern 12, and iii) the first cover member 14, having a dielectric constant higher than the dielectric constant of the plate-like substrate 11, that covers at least a portion of the loop formed with the conductive pattern 12 above the conductive pattern 12 on the top surface of the plate-like substrate 11. Since the RF tag 1 has the first cover member 14 having a dielectric constant higher than the dielectric constant of the plate-like substrate 11, the resonance frequency of the RF tag 1 becomes lower compared to when the RF tag 1 does not have the first cover member 14, and approaches the resonance frequency when a dielectric is brought near from the outside. As a result, the resonance frequency of the RF tag 1 is less likely to fluctuate even when a dielectric approaches the RF tag 1 from the outside or a dielectric is in contact with the RF tag 1.

Further, as the RF tag 1 possesses the first cover member 14 with a dielectric constant higher than that of the plate-like substrate 11, the gain increases while the resonance frequency is lowered, allowing the suppression of gain reduction even when the RF tag 1 is miniaturized. Moreover, since the resonance frequency can be easily adjusted by modifying the material or thickness of the first cover member 14, the RF tag 1 can be designed to achieve the desired resonance frequency.

The present disclosure is explained on the basis of the exemplary embodiments. The technical scope of the present disclosure is not limited to the scope explained in the above embodiments and it is possible to make various changes and modifications within the scope of the disclosure. Further, new exemplary embodiments generated by arbitrary combinations of them are included in the exemplary embodiments of the present disclosure.

What is claimed is:

1. An RF tag capable of transmitting and receiving data via radio waves, comprising:
a plate-like substrate that is formed of a dielectric;
a loop-shaped conductive pattern that is formed on one or more surfaces of the plate-like substrate;
a semiconductor device that is provided between a first end and a second end of the conductive pattern, stores the data, and includes a circuit transmitting and receiving the data via radio waves; and,
a first cover member that covers at least a portion of the conductive pattern above the conductive pattern on a top surface of the plate-like substrate and has a first dielectric constant that is higher than a dielectric constant of the plate-like substrate, wherein
the RF tag has characteristics in which i) a gain increases while a resonance frequency shifts toward a lower frequency as an external dielectric approaches the RF tag, ii) a resonance frequency when the external dielectric is in contact with the RF tag is lower than a resonance frequency when the external dielectric is not in contact with the RF tag, and iii) the gain is larger when the external dielectric is in contact with the RF tag than when the external dielectric is not in contact with the RF tag, and
an area of the conductive pattern on a bottom surface of the plate-like substrate is equal to or larger than an area of the conductive pattern on a top surface of the plate-like substrate.

2. The RF tag according to claim 1, wherein
the first cover member covers 50% or more of the conductive pattern on the top surface of the plate-like substrate.

3. The RF tag according to claim 1, wherein
the first cover member covers at least a portion of a region of the conductive pattern farther from a connecting position between the conductive pattern on the top surface of the plate-like substrate and the conductive pattern on the bottom surface of the plate-like substrate relative to a center position of the RF tag.

4. The RF tag according to claim 1, wherein
the first cover member further covers the conductive pattern on a side surface and the bottom surface of the plate-like substrate.

5. The RF tag according to claim 1, wherein
the first cover member covers at least a portion of the conductive pattern above the conductive pattern on the top surface of the plate-like substrate in a state where there is no gap between the first cover member and the conductive pattern.

6. The RF tag according to claim 1, further comprising:
an intermediate layer, having a second dielectric constant that is lower than the first dielectric constant, between a) at least a portion of the conductive pattern on the top surface and the semiconductor device and b) the first cover member.

7. The RF tag according to claim 1, comprising:
a gap that is between a) at least a portion of the conductive pattern of the top surface and the semiconductor device and b) the first cover member.

8. The RF tag according to claim 1, further comprising:
a second cover member, having a third dielectric constant that is higher than the first dielectric constant, that covers the first cover member.

9. The RF tag according to claim 8, wherein
a plurality of plate-like members having the third dielectric constant are stacked in the second cover member.

10. The RF tag according to claim 1, wherein
a plurality of plate-like members having the first dielectric constant are stacked in the first cover member.

11. The RF tag according to claim 1, wherein
the first cover member covers 50% or more of an area of the top surface of the plate-like substrate.
